(19) United States
(12) Patent Application Publication
(10) Pub. No.: US 2023/0004926 A1
(43) Pub. Date: Jan. 5, 2023

(54) Management System, and Method for Managing Entering and Dispatching of Products

(71) Applicant: Hitachi Industrial Products, Ltd., Chiyoda-ku, Tokyo (JP)

(72) Inventor: Akiharu IKEDA, Tokyo (JP)

(21) Appl. No.: 17/780,579

(22) PCT Filed: Nov. 6, 2020
(86) PCT No.: PCT/JP2020/041577

§ 371 Date: May 27, 2022

(30) Foreign Application Priority Data
Dec. 5, 2019 (JP) 2019-220714

(51) Int. Cl. G06Q 10/08; G06Q 50/28; B65G 1/137

(52) U.S. Cl. CPC G06Q 10/087; G06Q 50/28; G06Q 10/083; B65G 1/137

(57) ABSTRACT

A management system for managing entering and dispatching of products to be managed in a warehouse. The warehouse includes racks, a transfer robot, and picking stations. The management system comprises: a product group generation module configured to generate, based on relevance among products in the picking work, product groups; an allocated-rack determination module configured to determine, for each one of the product groups, allocation of the racks; an allocated-picking station determination module configured to determine, for each one of the product groups, allocation of the picking stations; and a transfer robot controller configured to control the transfer robot. The allocated-picking station determination module determines the picking stations that is at a shortest distance from the racks that is allocated to the product group, as the picking stations that is to be allocated to the product group.

### INCORPORATION BY REFERENCE

The present application claims priority to Japanese Patent Application No. 2019-220714 filed on Dec. 5, 2019, the content of which is incorporated herein by reference.

### BACKGROUND OF THE INVENTION

This invention relates to a system for managing logistics.

A transfer robot tasked with work of conveying packages is called an unmanned carrier or an automatic guided vehicle (AGV). The transfer robot is widely introduced in such facilities as warehouses, factories, and ports.

In response to diversification of customer needs in recent years, warehouses handling many types of products each in a small lot, such as warehouses for mail-order businesses, are increasing in number. Products to be managed require, by nature, time and personnel cost to search for and load. For that reason, demands for automation of logistics work inside a facility are greater in warehouses for mail-order businesses than in warehouses handling one type of product in a large quantity.

For example, there has been known a system using a transfer robot which conveys a rack for housing products to raise efficiency of warehouse management. The transfer robot conveys the rack inside a warehouse following an instruction of the system which performs overall warehouse management.

A technology as described in JP 2000-351422 A has been known as a technology for determining placement of products inside a warehouse. In JP 2000-351422 A, there is included description “in a commercial product placement planning support system for determining locations at which a plurality of commercial products are to be stored out of a plurality of predetermined storage areas, information about degrees of relevance determined for the commercial products based on simultaneity of work to be performed after the commercial products are stored is obtained, and locations at which the commercial products are to be stored are determined in accordance with the degrees of relevance out of the plurality of storage areas, based on the obtained information about the degrees of relevance of the commercial products.”

### SUMMARY OF THE INVENTION

A premise of the technology as described in JP 2000-351422 A is that a worker travels to a storage area and performs work there. In systems of recent years, on the other hand, a transfer robot moves a rack for housing products to a picking station, and a worker performs picking work at the picking station. Accordingly, in order to raise efficiency of the picking work, determination of an appropriate picking station to perform picking work at is also required. Only a limited amount of rise in the efficiency of the picking work is consequently expected from the technology as described in JP 2000-351422 A alone.

This invention provides a system and a method which determine product storage locations and picking station allocation that accomplish a raised efficiency of picking work.

A representative example of the present invention disclosed in this specification is as follows: a management system for managing entering and dispatching of products to be managed in a warehouse. The warehouse includes a plurality of racks each of which stores the products, at least one transfer robot configured to convey a rack, and a plurality of picking stations at which workers perform picking work on the rack conveyed by the at least one transfer robot. The management system comprises: a product group generation module configured to generate, based on relevance among the products in the picking work, a plurality of product groups each including a plurality of products; an allocated-rack determination module configured to determine, for each one of the plurality of product groups, allocation of at least one of the plurality of racks in which the plurality of products belonging to the one of the plurality of product groups are to be stored; an allocated-picking station determination module configured to determine, for each one of the plurality of product groups, allocation of at least one of the plurality of picking stations to be used for the picking work of the plurality of products belonging to the one of the plurality of product groups; and a transfer robot controller configured to control the at least one transfer robot so that the at least one transfer robot conveys the at least one of the plurality of racks allocated to the one of the plurality of product groups to the at least one of the plurality of picking stations allocated to the one of the plurality of product groups. The allocated-picking station determination module is configured to: select a target product group out of the plurality of product groups; and determine one of the plurality of picking stations that is at a shortest distance from the at least one of the plurality of racks that is allocated to the target product group, as the at least one of the plurality of picking stations that is to be allocated to the target product group.

According to this invention, the product storage locations and picking station allocation that accomplish a raised efficiency of picking work can be determined. Other problems, configurations, and effects than those described above will become apparent in the descriptions of embodiments below.

### BRIEF DESCRIPTION OF THE DRAWINGS

The present invention can be appreciated by the description which follows in conjunction with the following figures, wherein:

FIG. 1 is a diagram for illustrating an example of a configuration of a warehouse management system of a first embodiment of this invention;

FIG. 2 is a perspective view for illustrating an example of a warehouse in the first embodiment;

FIG. 3 is a plan view for illustrating an example of the warehouse in the first embodiment;

FIG. 4 is a table for showing an example of data structure of allocation information in the first embodiment;

FIG. 5 is a flow chart for illustrating an example of processing executed by a control system in the first embodiment in order to determine allocated racks and allocated picking stations;

FIG. 6 is a flow chart for illustrating an example of processing executed by the control system in the first embodiment in order to generate work data; and

FIG. 7 is a flow chart for illustrating an example of processing executed by the control system in a second embodiment in order to change allocation of the picking stations.

### DETAILED DESCRIPTION OF THE PREFERRED EMBODIMENTS

Now, a description is given of an embodiment of this invention referring to the drawings. It should be noted that this invention is not to be construed by limiting the invention to the content described in the following embodiment. A person skilled in the art would easily recognize that a specific configuration described in the following embodiment may be changed within the scope of the concept and the gist of this invention.

In the following description, expressions of “table”, “list”, and “queue” are sometimes used as an example of information, but any kind of data structure of information may be used. In other words, in order to indicate that the information does not depend on the data structure, the “xx table” and the “xx list” may be paraphrased as “xxx information”. When explaining the content of each information, expression such as “identification information”, “identifier”, “name”, “ID”, and “number” are used, but these can be replaced with each other.

In a configuration of this invention described below, the same or similar components or functions are assigned with the same reference numerals, and a redundant description thereof is omitted here.

Notations of, for example, “first”, “second”, and “third” herein are assigned to distinguish between components, and do not necessarily limit the number or order of those components.

The position, size, shape, range, and others of each component illustrated in, for example, the drawings may not represent the actual position, size, shape, range, and other metrics in order to facilitate understanding of this invention. Thus, this invention is not limited to the position, size, shape, range, and others described in, for example, the drawings.

### First Embodiment

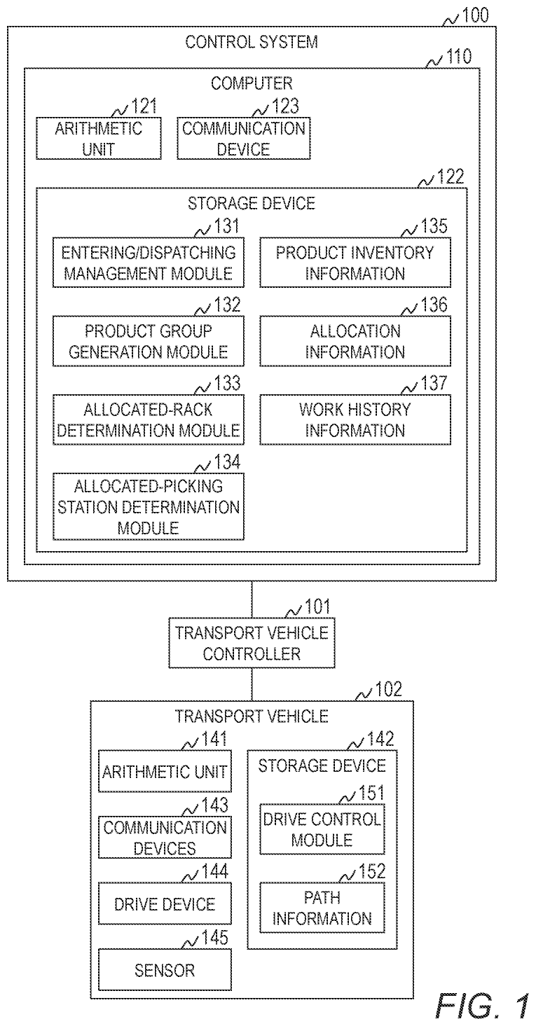

FIG. 1 is a diagram for illustrating an example of a configuration of a warehouse management system of a first embodiment of this invention.

The warehouse management system includes a control system 100, a transport vehicle controller 101, and a transport vehicle 102.

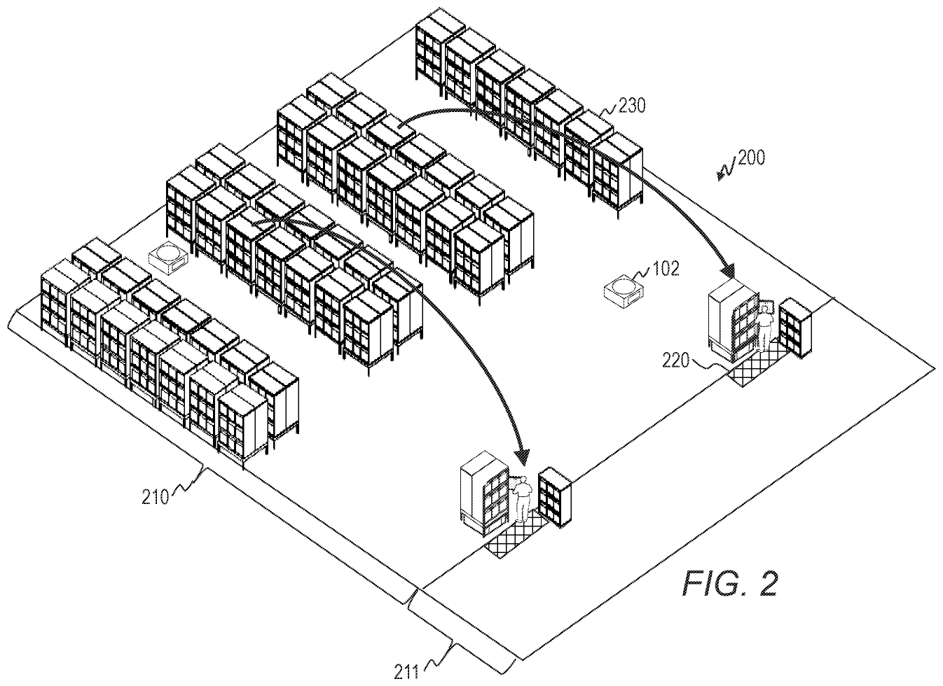

The transport vehicle 102 is placed in a warehouse 200 (illustrated in FIG. 2) in which at least one type of picking work out of carrying in of products, carrying out of products, and exchanging of products between shelves is performed. The control system 100 and the transport vehicle controller 101 may be placed in the warehouse 200 or a place other than the warehouse 200.

The control system 100 couples to the transport vehicle controller 101 via a network. The transport vehicle controller 101 couples to the transport vehicle 102 via the network.

Examples of the network include a local area network (LAN) and a wide area network (WAN). The network may be coupled by a cable or in a wireless manner.

The warehouse management system may include more than one transport vehicle controller 101 and more than one transport vehicle 102.

The control system 100 executes overall control of the warehouse management system. The control system 100 includes at least one computer 110.

The computer 110 includes an arithmetic unit 121, a storage device 122, and a communication device 123.

Examples of the arithmetic unit 121 includes a processor, a graphics processing unit (GPU), and a field-programmable gate array (FPGA), and the arithmetic unit 121 executes a program stored in the storage device 122. The arithmetic unit 121 operates as a function module which implements a specific function, by executing processing in accordance with the program. In the following description, when a function module is the subject of a sentence describing processing, this means that the arithmetic unit 121 is executing a program that implements the function module.

The storage device 122 is a memory or the like, and stores a program to be executed by the arithmetic unit 121 and information to be used by the program. The storage device 122 includes a work area temporarily used by the program.

The communication device 123 holds communication to and from an external apparatus over the network. The communication device 123 is, for example, a network interface.

The storage device 122 stores programs which implement an entering/dispatching management module 131, a product group generation module 132, an allocated-rack determination module 133, and an allocated-picking station determination module 134, and also stores product inventory information 135, allocation information 136, and work history information 137.

The product inventory information 135 is information for managing inventory of products housed in racks 230 (illustrated in FIG. 2). For example, the product inventory information 135 stores data associating one of the racks 230, a type of a product, the number of pieces of the product that are in stock, and a shipping source or a shipping destination (a transaction partner) of the product with one another.

The allocation information 136 is information for managing products that form a product group, and the racks 230 and picking stations 220 (illustrated in FIG. 2) that are allocated to one product group. Details of data structure of the allocation information 136 are described with reference to FIG. 4.

The work history information 137 is information for managing history of picking work performed in the warehouse management system.

The storage device 122 stores information for managing positions of the picking stations 220 and the racks 230 in the warehouse 200 and other types of information, which are omitted.

The entering/dispatch management module 131 determines contents of picking work including the type of a product, the number of pieces of the product, the type of work, and the like, as well as the racks 230 and the picking stations 220 at which the picking work is to be performed, the order of steps of the work, the length of an execution time of the picking work, restrictions placed on the picking work, and others, and generates work data including the determined items. The product group generation module 132 generates a product group. The allocated-rack determination module 133 determines which one or which ones of the racks 230 are to be allocated to one product group. The allocated-picking station determination module 134 determines which one or which ones of the picking stations 220 are to be allocated to one product group.

The transport vehicle controller 101 controls the transport vehicle 102. The transport vehicle controller 101 has the same hardware configuration as the hardware configuration of the computer 110, and description thereof is accordingly omitted. The transport vehicle controller 101 generates path information 152 for controlling the transport vehicle 102 under an instruction from the control system 100.

The transport vehicle 102 goes into a gap under the racks 230 (illustrated in FIG. 2), loads one of the racks 230 onto itself at a predetermined position, and conveys the one of the racks 230 to a target position. The transport vehicle 102 includes an arithmetic unit 141, a storage device 142, a communication device 143, drive devices 144, and a sensor 145. The arithmetic unit 141, the storage device 142, and the communication device 143 are pieces of hardware similar to the arithmetic unit 121, the storage device 122, and the communication device 123, respectively.

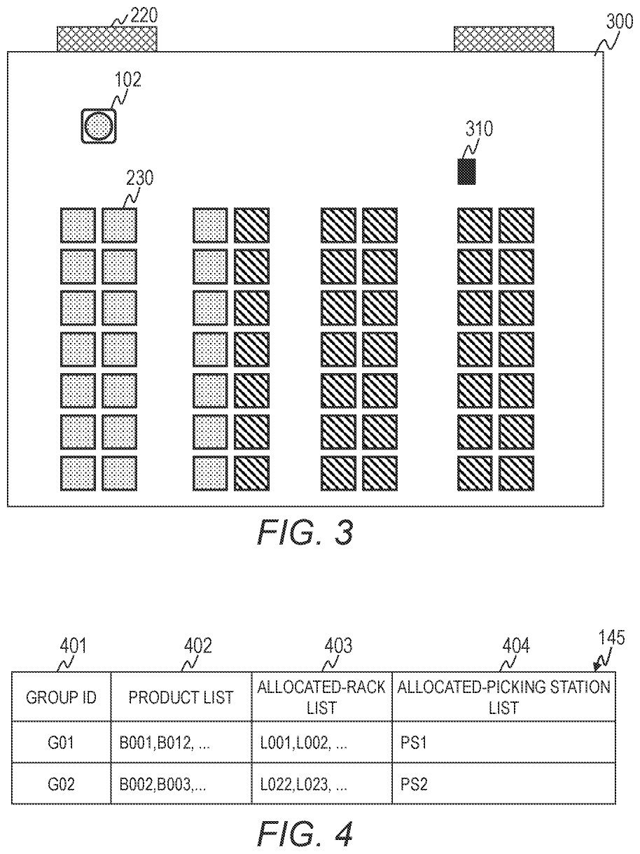

The drive devices 144 are a motor, a drive wheel, or a similar device used to convey the racks 230. The sensor 145 is a device which detects a situation of surroundings of the transport vehicle 102 in order to specify a position of the transport vehicle 102 in a warehouse area 210 (illustrated in FIG. 2). The sensor 145 is, for example, a camera, and reads a marker 310 (illustrated in FIG. 3) set on a floor surface 300 (illustrated in FIG. 3). The sensor 145 may also be a sensor that measures a distance (for example, a laser distance sensor) between the transport vehicle 102 and an object in the surroundings. The transport vehicle 102 specifies its own position based on the marker 310 read with the use of the sensor 145, or specifies its own position through comparison between shape data of a surrounding environment measured with the use of the sensor 145 and a map.

The storage device 142 stores a program that implements a drive control module 151, and also stores the path information 152. The storage device 142 may store map information for managing a space in which the transport vehicle 102 can travel.

The path information 152 is information about conveyance paths of the racks 230. The drive control module 151 executes conveyance of the racks 230 based on the path information 152.

FIG. 2 is a perspective view for illustrating an example of the warehouse 200 in the first embodiment. FIG. 3 is a plan view for illustrating an example of the warehouse 200 in the first embodiment.

The warehouse 200 includes a zone enclosed by wire mesh walls or other types of walls. In FIG. 2, one zone is set in the warehouse 200. The one zone includes the warehouse area 210 and a picking area 211.

The warehouse area 210 is an area in which the transport vehicle 102 and the racks 230 are placed. The warehouse area 210 may be said as a work space. The picking area 211 is an area for a worker to perform picking work on the racks 230. The picking stations 220 at which the worker performs the picking work are provided at a border between the warehouse area 210 and the picking area 211. The racks 230 on which the picking work is to be performed are placed in areas adjacent to the picking stations 220.

The racks 230 each have an entering/dispatching port through which a product is housed or taken out. In the first embodiment, placement of the racks 230 is managed so that a plurality of racks out of the racks 230 form a “block of racks.”

The transport vehicle 102 can take one of the racks 230 that is a target rack out of a block of racks and convey the target rack to one of the picking stations 220, based on the path information 152. The transport vehicle 102 can also convey one of the racks 230 to a block of racks from one of the picking stations 220.

The floor surface 300 of the warehouse 200 on which the zone is formed is marked with the marker 310 indicating a position on the floor surface 300. Although the floor surface 300 is marked with only one marker 310 in FIG. 3, the floor surface 300 is actually marked with more than one marker 310.

The transport vehicle 102 is mounted with a camera for detecting the marker 310. The camera is an example of the sensor 145.

In FIG. 3, the racks 230 allocated to a first product group are indicated by a dot pattern and the racks 230 allocated to a second product group are indicated by a diagonal hatch pattern.

FIG. 4 is a table for showing an example of data structure of the allocation information 136 in the first embodiment.

The allocation information 136 stores entries each including a group ID 401, a product list 402, an allocated-rack list 403, and an allocated-picking station list 404. The allocation information 136 has one entry for one product group.

The group ID 401 is a field in which identification information of a product group is stored. The product list 402 is a field in which pieces of identification information of products belonging to the product group are stored. The allocated-rack list 403 is a field in which pieces of identification information of the racks 230 allocated to the product group are stored. The allocated-picking station list 404 is a field in which pieces of identification information of the picking stations 220 allocated to the product group are stored. Racks allocated to each product group (allocated racks) may be changed depending on quantities of products that are in stock and stored in the warehouse, and an increase or decrease in number of product types.

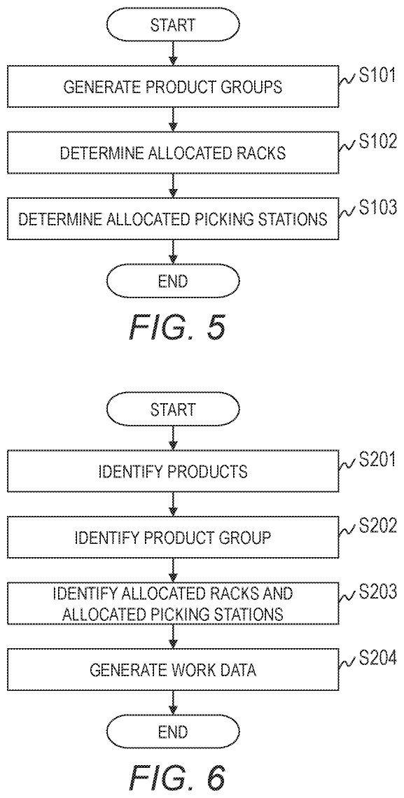

FIG. 5 is a flow chart for illustrating an example of processing executed by the control system 100 in the first embodiment in order to determine the allocated racks 230 and the allocated picking stations 220.

The control system 100 executes processing described below in a case of receiving an execution instruction from an administrator, in a case of building or adding a new warehouse 200.

The product group generation module 132 of the control system 100 generates a plurality of product groups based on relevance between products in picking work (Step S101). The plurality of product groups are each given unique identification information by the product group generation module 132.

Methods that may be used to generate the plurality of product groups are as follows.

(Generation Method 1) The product group generation module 132 identifies products shipped from the same source among products entered into the warehouse 200, and generates a product group that has the identified products as elements. The product group generation module 132 also identifies, through analysis of the work history information 137, products sharing the same transaction partner among products to be dispatched, and generates a product group that has the identified products as elements.

Efficiency can be raised in terms of the number of the racks 230 conveyed, the number of times of conveyance of the racks 230, and entering and dispatching of products, by storing products that share the same shipping source or the same transaction partner in one place.

(Generation Method 2) The product group generation module 132 analyzes the work history information 137 to calculate an index for evaluating relevance between products in picking work. An example of the index to be calculated is a value calculated based on the simultaneity of work (the level of possibility at which picking work is simultaneously performed on different products) which is described in JP 2000-351422 A. Any index is usable in this invention as long as relevance between products in picking work can be evaluated. Efficiency can be raised in terms of the number of the racks 230 conveyed, the number of times of conveyance of the racks 230, and entering and dispatching of products, by managing together the products for which shipping work and the like are simultaneously executed.

This concludes the description on the methods of generating a product group.

The product group generation module 132, in a case of generating a product group, adds an entry for a generated product group to the allocation information 136, and sets identification information of the product group to the group ID 401 of the added entry. The product group generation module 132 also sets pieces of identification information of products belonging to the product group to the product list 402 of the added entry.

Next, the allocated-rack determination module 133 of the control system 100 determines the allocated racks 230 for each of the plurality of product groups (Step S102). Specifically, the following processing is executed.

(Step S102-1) The allocated-rack determination module 133 selects a target product group from among the plurality of product groups.

(Step S102-2) The allocated-rack determination module 133 determines the allocated racks 230 to be allocated to the target product group.

As a method of allocating the racks 230, the method as described in JP 2000-351422 A, for example, may be used. One rack or a plurality of racks may be allocated to one product group as the allocated racks 230.

(Step S102-3) The allocated-rack determination module 133 refers to the allocation information 136 to search for an entry in which identification information of the target product group is stored as the group ID 401. The allocated-rack determination module 133 sets identification information of the allocated racks 230 to the allocated-rack list 403 of the entry found as a result of the search.

(Step S102-4) The allocated-rack determination module 133 determines whether determination of the allocated racks 230 is finished for every product group. In a case where determination of the allocated racks 230 is not finished for every product group, the process returns to Step S102-1, and the allocated-rack determination module 133 executes the same processing. In a case where determination of the allocated racks 230 is finished for every product group, the allocated-rack determination module 133 ends the processing step of Step S102.

This concludes the description on the processing step of Step S102. Next, the allocated-picking station determination module 134 of the control system 100 determines the allocated picking stations 220 for each of the plurality of product groups (Step S103). The control system 100 then ends the processing. Specifically, the following processing is executed.

(Step S103-1) The allocated-picking station determination module 134 selects a target product group from among the plurality of product groups.

(Step S103-2) The allocated-picking station determination module 134 refers to the allocation information 136 to search for an entry in which identification information of the target product group is stored as the group ID 401. The allocated-picking station determination module 134 obtains pieces of identification information of the allocated racks 230 from the allocated-rack list 403 of the entry found as a result of the search.

(Step S103-3) The allocated-picking station determination module 134 selects one of the allocated racks 230 of the target product group as a target allocated rack 230. The allocated-picking station determination module 134 calculates a distance from the one of the allocated racks 230 selected as a target allocated rack 230 to each of the picking stations 220. The calculation may exclude the picking stations 220 allocated to product groups other than the target product group.

When the plurality of product groups are generated by Generation Method 1, the allocated-picking station determination module 134 refers to the work history information 137 to identify shipping sources or transaction partners in picking work executed at the picking stations 220. For example, a shipping source or a transaction partner in picking work may be identified based on the number of times the picking work for the shipping source or the transaction partner has been executed. The allocated-picking station determination module 134 identifies one of the picking stations 220 as a picking station for which the identified shipping source or transaction partner matches a shipping source or a transaction partner associated with the target product group. The allocated-picking station determination module 134 calculates a distance between the one of the allocated racks 230 selected as a target allocated rack 230 and the one of the picking stations 220 that is identified.

(Step S103-4) The allocated-picking station determination module 134 determines whether execution of the processing step of Step S103-3 is finished for every one of the allocated racks 230 of the target product group. In a case where the allocated-picking station determination module 134 has not finished execution of the processing step of Step S103-3 for every one of the allocated racks 230 of the target product group, the process returns to

Step S103-3, and the allocated-picking station determination module 134 executes the same processing. In a case where the allocated-picking station determination module 134 has finished execution of the processing step of Step S103-3 for every one of the allocated racks 230 of the target product group, the process proceeds to Step S103-5.

(Step S103-5) The allocated-picking station determination module 134 calculates, for each of the picking stations 220, a sum value of the distances, and selects a predetermined number of picking stations 220 in ascending order of the sum values. The number of picking stations 220 to be selected is set in advance.

(Step S103-6) The allocated-picking station determination module 134 sets pieces of identification information of the selected picking stations 220 to the allocated-picking station list 404 of the entry found in Step S103-2.

In the first embodiment, the allocated picking stations 220 are determined so that distances between the allocated racks 230 and the picking stations 220 are short. In a case where there are a plurality of allocated racks 230, the allocated picking stations 220 are determined by the processing described above. The processing described above is an example, and this invention is not limited thereto. For instance, in Step S103-5, the allocated-picking station determination module 134 may determine the allocated picking stations 220 based on an average value or the like of distances between the allocated racks 230 and the picking stations 220.

A distance over which each of the racks 230 is conveyed in picking work can be decreased by shortening distances between the allocated racks 230 and the allocated picking stations 220. In this manner, the efficiency of the picking work is improved.

This concludes the description on the processing step of Step S103.

The allocation information 136 as the one shown in FIG. 4 is generated by executing the processing described with reference to FIG. 5.

FIG. 6 is a flow chart for illustrating an example of processing executed by the control system 100 in the first embodiment in order to generate work data.

In a case where one event out of entering of a product and dispatching of a product is detected, the control system 100 executes processing described below. For example, the control system 100 detects reception of a request that is placement of order as a product dispatching event.

The entering/dispatching management module 131 identifies a product for which picking work is to be executed, based on information about the event (Step S201). At this point, the entering/dispatching management module 131 refers to the product inventory information 135 to obtain identification information of the identified product.

The entering/dispatching management module 131 next identifies a product group to which the identified product belongs (Step S202).

Specifically, the entering/dispatching management module 131 refers to the allocation information 136 to search for an entry in which identification information of the identified product is stored in the product list 402.

Next, the entering/dispatching management module 131 identifies the allocated racks 230 and the allocated picking stations 220 of the identified product group (Step S203).

Specifically, the entering/dispatching management module 131 obtains pieces of identification information from each of the allocated-rack list 403 and the allocated-picking station list 404 of the entry found as a result of the search in Step S202.

The entering/dispatching management module 131 next generates work data based on the information about the event, the identified product, the identified allocated racks 230, and the identified allocated picking stations 220 (Step S204). The entering/dispatching management module 131 then ends the processing.

After the processing illustrated in FIG. 6 is ended, the entering/dispatching management module 131 starts control of the picking work based on the work data.

For example, the entering/dispatching management module 131 generates rack conveyance information which is information about conveyance of the racks 230, based on the work data, and transmits the rack conveyance information to the transport vehicle controller 101. The rack conveyance information includes data including, among others, pieces of identification information of the racks 230, pieces of identification information of the picking stations 220, and an order of conveyance. The transport vehicle controller 101 generates the path information 152 based on the rack conveyance information, and transmits the path information 152 to the transport vehicle 102.

The entering/dispatching management module 131 also generates information for presenting contents of the picking work and the like to a worker, based on the work data, and transmits the information to a terminal of the worker, an apparatus on which projection mapping is displayed, or the like.

According to the first embodiment, the control system 100 allocates the allocated racks 230 for each product group generated based on relevance between products in picking work. The control system 100 also determines the allocated picking stations 220 of the product group so that distances between the allocated racks 230 and the allocated picking stations 220 are short.

The configuration described above enables grouping together of the racks 230 at which picking work is to be executed, and shortening of distances over which the racks 230 are conveyed by the transport vehicle 102. A rise in the efficiency of the picking work is accordingly accomplished. Overall efficiency of operation of the ware house 200 including the entering of a product and the dispatching of a product can be improved as well.

### Second Embodiment

In a second embodiment of this invention, the control system 100 changes allocation of the picking stations 220 when picking work of one product group is finished. Description of the second embodiment is given below, with a focus on differences from the first embodiment.

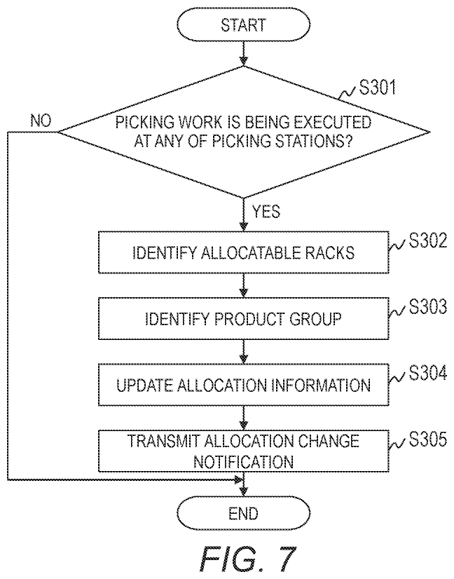

A warehouse management system of the second embodiment is the same as the warehouse management system of the first embodiment, and description thereof is accordingly omitted. FIG. 7 is a flow chart for illustrating an example of processing executed by the control system 100 in the second embodiment in order to change allocation of the picking stations 220. In the second embodiment, one of the picking stations 220 is allocated to one product group.

In a case where the end of picking work is detected, the allocated-rack determination module 133 of the control system 100 executes processing described below. The end of picking work is detected by, for example, the entering/dispatching management module 131. In this case, the entering/dispatching management module 131 refers to the allocation information 136 to identify a product group to which one of the racks 230 for which the picking work is ended is allocated, and inputs identification information of the identified product group to the allocated-rack determination module 133.

The allocated-rack determination module 133 issues an inquiry to the entering/dispatching management module 131 to determine whether picking work is currently being executed at any of the picking stations 220 (Step S301).

In a case where picking work is currently being executed at one of the picking stations 220, the entering/dispatching management module 131 transmits a response including identification information of the one of the picking stations 220 at which picking work is being executed to the allocated-rack determination module 133.

In a case where it is determined that picking work is being executed at none of the picking stations 220, the allocated-rack determination module 133 ends the processing.

In a case where it is determined that picking work is being executed at one of the picking stations 220, the allocated-rack determination module 133 identifies the racks 230 that can be allocated to a product group to which the one of the picking stations 220 is allocated (Step S302).

Specifically, the allocated-rack determination module 133 refers to the allocation information 136 to search for an entry in which the identification information of the product group received from the entering/dispatching management module 131 at the start of the processing is stored as the group ID 401. The allocated-rack determination module 133 obtains identification information stored in the allocated-rack list 403 of the entry found as a result of the search. At this point, the allocated-rack determination module 133 may change a cell for the allocated-rack list 403 of the found entry to a null cell.

Next, the allocated-rack determination module 133 identifies the product group to which the one of the picking stations 220 at which picking work is being executed is allocated (Step S303).

Specifically, the allocated-rack determination module 133 refers to the allocation information 136 to search for an entry in which the identification information of the one of the picking stations 220 included in the response is stored in the allocated-picking station list 404. The allocated-rack determination module 133 obtains the value of the group ID 401 of the entry found as a result of the search.

The allocated-rack determination module 133 next updates the allocation information 136 (Step S304).

Specifically, the allocated-rack determination module 133 refers to the allocation information 136 and sets the identification information of the racks 230 obtained in Step 5302 to the allocated-rack list 403 of the entry found in Step 5303.

Next, the allocated-rack determination module 133 transmits an allocation change notification to the entering/dispatching management module 131 (Step S305). The allocation change notification includes the identification information of the product group identified in Step 5303. The allocated-rack determination module 133 then ends the processing.

The entering/dispatching management module 131 receives the allocation change notification, modifies work data related to the product group that is included in the allocation change notification, generates rack conveyance information from the modified work data, and transmits a conveyance change instruction including the rack conveyance information to the transport vehicle controller 101.

The transport vehicle controller 101 receives the conveyance change instruction, and generates the path information 152 with the use of the rack conveyance information included in the conveyance change instruction, instead of a previously received rack conveyance path.

The transport vehicle 102 conveys the allocated racks 230 to one of the picking stations 220 that is the originally allocated picking station and another of the picking stations 220 that is the newly allocated picking station, in accordance with the new path information 152.

According to the second embodiment, when picking work is finished at one of the picking stations 220, the one of the picking stations 220 is allocated to another picking work. It is consequently possible to improve the efficiency of picking work in the warehouse 200.

The present invention is not limited to the above embodiment and includes various modification examples. In addition, for example, the configurations of the above embodiment are described in detail so as to describe the present invention comprehensibly. The present invention is not necessarily limited to the embodiment that is provided with all of the configurations described. In addition, a part of each configuration of the embodiment may be removed, substituted, or added to other configurations.

A part or the entirety of each of the above configurations, functions, processing units, processing means, and the like may be realized by hardware, such as by designing integrated circuits therefor. In addition, the present invention can be realized by program codes of software that realizes the functions of the embodiment. In this case, a storage medium on which the program codes are recorded is provided to a computer, and a CPU that the computer is provided with reads the program codes stored on the storage medium. In this case, the program codes read from the storage medium realize the functions of the above embodiment, and the program codes and the storage medium storing the program codes constitute the present invention. Examples of such a storage medium used for supplying program codes include a flexible disk, a CD-ROM, a DVD-ROM, a hard disk, a solid state drive (SSD), an optical disc, a magneto-optical disc, a CD-R, a magnetic tape, a non-volatile memory card, and a ROM.

The program codes that realize the functions written in the present embodiment can be implemented by a wide range of programming and scripting languages such as assembler, C/C++, Perl, shell scripts, PHP, Python, and Java.

It may also be possible that the program codes of the software that realizes the functions of the embodiment are stored on storing means such as a hard disk or a memory of the computer or on a storage medium such as a CD-RW or a CD-R by distributing the program codes through a network and that the CPU that the computer is provided with reads and executes the program codes stored on the storing means or on the storage medium.

In the above embodiment, only control lines and information lines that are considered as necessary for description are illustrated, and all the control lines and information lines of a product are not necessarily illustrated. All of the configurations of the embodiment may be connected to each other.

What is claimed is:

1. A management system for managing entering and dispatching of products to be managed in a warehouse,
the warehouse including a plurality of racks each of which stores the products, at least one transfer robot configured to convey a rack, and a plurality of picking stations at which workers perform picking work on the rack conveyed by the at least one transfer robot,
the management system comprising:
a product group generation module configured to generate, based on relevance among the products in the picking work, a plurality of product groups each including a plurality of products;
an allocated-rack determination module configured to determine, for each one of the plurality of product groups, allocation of at least one of the plurality of racks in which the plurality of products belonging to the one of the plurality of product groups are to be stored;
an allocated-picking station determination module configured to determine, for each one of the plurality of product groups, allocation of at least one of the plurality of picking stations to be used for the picking work of the plurality of products belonging to the one of the plurality of product groups; and
a transfer robot controller configured to control the at least one transfer robot so that the at least one transfer robot conveys the at least one of the plurality of racks allocated to the one of the plurality of product groups to the at least one of the plurality of picking stations allocated to the one of the plurality of product groups,
the allocated-picking station determination module being configured to:
select a target product group out of the plurality of product groups; and
determine one of the plurality of picking stations that is at a shortest distance from the at least one of the plurality of racks that is allocated to the target product group, as the at least one of the plurality of picking stations that is to be allocated to the target product group.

2. The management system according to claim 1, wherein the product group generation module is configured to generate the plurality of product groups each including a plurality of products that share the same shipping source.

3. The management system according to claim 2, wherein the allocated-picking station determination module is configured to determine, out of some of the plurality of picking stations at which picking work has been executed for products belonging to the target product group, one of the some of the plurality of picking stations that is at a shortest distance from the one of the plurality of racks that is allocated to the target product group, as one of the plurality of picking stations that is to be allocated to the target product group.

4. The management system according to claim 1,
wherein the management system is configured to manage history information in which history of the picking work is stored, and
wherein the product group generation module is configured to:
identify, through analysis of the history, combinations of products for which the picking work is likely to be executed at the same time; and
generate each of the plurality of product groups from one combination of products out of the identified combinations of products.

5. The management system according to claim 1,
wherein the plurality of product groups include a first product group,
wherein the plurality of picking stations include a first picking station,
wherein the first picking station is allocated to the first product group,
wherein the allocated-picking station determination module is configured to:
identify, in a case where an end of the picking work for the first product group is detected, another product group for which the picking work is being executed out of the plurality of product groups; and
allocate the first picking station to the another product group, and
wherein the transfer robot controller is configured to control the at least one transfer robot so that the at least one transfer robot conveys the at least one of the plurality of racks allocated to the another product group to either the first picking station or the at least one of the plurality of picking stations allocated to the another product group.

6. A method for managing entering and dispatching of products to be managed in a warehouse, which is to be executed by a management system,
the warehouse including a plurality of racks each of which stores the products, at least one transfer robot configured to convey a rack, and a plurality of picking stations at which workers perform picking work on the rack conveyed by the at least one transfer robot,
the management system including a computer configured to control the picking work, and a transfer robot controller configured to control the at least one transfer robot,
the method for managing entering and dispatching of products including:
a first step of generating, by the computer, based on relevance among the products in the picking work, a plurality of product groups each including a plurality of products;
a second step of determining, by the computer, for each one of the plurality of product groups, allocation of at least one of the plurality of racks in which the plurality of products belonging to the one of the plurality of product groups are to be stored;
a third step of determining, by the computer, for each one of the plurality of product groups, allocation at least one of the plurality of picking stations to be used for the picking work of the plurality of products belonging to the one of the plurality of product groups; and
a fourth step of controlling, by the transfer robot controller, the at least one transfer robot so that the at least one transfer robot conveys the at least one of the plurality of racks allocated to the one of the plurality of product groups to the at least one of the plurality of picking stations allocated to the one of the plurality of product groups,
the second step including:
a fifth step of selecting a target product group out of the plurality of product groups; and
a sixth step of determining one of the plurality of picking stations that is at a shortest distance from the at least one of the plurality of racks that is allocated to the target product group, as the at least one of the plurality of picking stations that is to be allocated to the target product group.

7. The method for managing entering and dispatching of products according to claim 6, wherein the first step includes generating, by the computer, the plurality of product groups each including a plurality of products that share the same shipping source.

8. The method for managing entering and dispatching of products according to claim 7, wherein the sixth step includes determining, by the computer, out of some of the plurality of picking stations at which picking work has been executed for products belonging to the target product group, one of the some of the plurality of picking stations that is at a shortest distance from the one of the plurality of racks that is allocated to the target product group, as one of the plurality of picking stations that is to be allocated to the target product group.

9. The method for managing entering and dispatching of products according to claim 6,
wherein the management system is configured to manage history information in which history of the picking work is stored, and
wherein the first step includes:
identifying, by the computer, through analysis of the history, combinations of products for which the picking work is likely to be executed at the same time; and
generating, by the computer, each of the plurality of product groups from one combination of products out of the identified combinations of products.

10. The method for managing entering and dispatching of products according to claim 6,
wherein the plurality of product groups include a first product group,
wherein the plurality of picking stations include a first picking station,
wherein the first picking station is allocated to the first product group, and
wherein the method for managing entering and dispatching of products further includes:
identifying, by the computer, in a case where an end of the picking work for the first product group is detected, another product group for which the picking work is being executed out of the plurality of product groups;
allocating, by the computer, the first picking station to the another product group; and
controlling, by the transfer robot controller, the at least one transfer robot so that the at least one transfer robot conveys the at least one of the plurality of racks allocated to the another product group to either the first picking station or the at least one of the plurality of picking stations allocated to the another product group.
